(19) United States
(12) Patent Application Publication
(10) Pub. No.: US 2026/0166814 A1
(43) Pub. Date: Jun. 18, 2026

(54) 3D PRINTING FROM GAS PHASE MONOMERS

(71) Applicant: UNIVERSITY OF FLORIDA RESEARCH FOUNDATION, INCORPORATED, Gainesville, FL (US)

(72) Inventors: Adam S. Veige, Gainesville, FL (US); Austin Evans, Gainesville, FL (US)

(21) Appl. No.: 18/811,887

(22) PCT Filed: Feb. 24, 2023
(86) PCT No.: PCT/US2023/013765

§ 371 Date: Aug. 22, 2024

Related U.S. Application Data
(60) Provisional application No. 63/313,589, filed on Feb. 24, 2022.

(51) Int. Cl. B29C 64/371; B29C 64/112; B33Y 10/00; B33Y 30/00; B33Y 40/00; B33Y 70/10

(52) U.S. Cl. CPC B29C 64/371; B29C 64/112; B33Y 10/00; B33Y 30/00; B33Y 40/00; B33Y 70/10

(57) ABSTRACT

Disclosed are methods and apparatus for forming three-dimensional articles from using layered gaseous deposition (LGD), comprising (a) depositing a solution comprising a catalyst and a solvent on a substrate to form a printed design, (b) contacting the printed design with a gas comprising a plurality of monomers comprising alkynes, alkenes, or a combination, forming a first layer of solid polymer; and (c) advancing the substrate away from the deposition means to form the three dimensional article.

### STATEMENT OF GOVERNMENT SUPPORT

This invention was made with government support under Grant Numbers 1808234 and 1265993, awarded by the National Science Foundation. The government has certain rights in the invention.

### FIELD OF THE DISCLOSURE

The disclosure relates generally to additive manufacturing of polymeric articles using gas phase monomers. More particularly, the disclosure relates to additive manufacturing of articles of cyclic polyacetylene from acetylene monomers.

### BACKGROUND

Flexible electronic devices are an emerging class of materials with a wide scope of applications. A growing market for flexible electronic devices centers on single-use electrodes, smart packaging labels, and other short-term electronic materials. Currently, single-use electrodes use cost-prohibitive silver metal as the charge carrying material during manufacturing.

Conductive inks are specifically designed for inkjet, screen-printing, or roll-to-roll processing methods in order to process large areas with fine-scale features in short time periods. Particle-based inks are based on conductive metal particles, which are typically synthesized separately and then incorporated into an ink formulation. The resulting ink is then tuned for the specific particle process. Precursor-based inks are based on thermally unstable precursor complexes that reduce to a conductive metal upon heating. Particle- and precursor-based methods generally rely on high temperatures to form conductive coatings and thus may not be compatible with substrates that require low processing temperatures to maintain integrity. For example, silver compounds with carbamate or other relatively low molecular weight ligands (compared to polymer stabilizers) have been synthesized that decompose at temperatures near 150° C., yielding electrical conductivities approaching that of bulk silver. Unfortunately, even these temperatures render the ink incompatible with many plastic and paper substrates used in flexible electronic and biomedical devices.

Rapid production and precise construction of devices are advantages of additive manufacturing, also commonly referred to as 3D printing. However, a significant disadvantage is the non-sustainable use of silver. For example, discarded after a single use, an electrode used to monitor patient vitals cannot be reused and the silver containing component is simply discarded. A better approach is to use a non-metallic flexible semi-conductor that retains the rapid and efficiency of 3D printing, but does not rely on precious metals. Semi-conducting polymers are replacement materials for silver in flexible electronics and specifically for single-use materials.

Currently, the common methods of 3D printing include sterolithography (SLA), selective laser sintering (SLS), and fused deposition modeling (FDM).

Linear polyacetylene is one of the highest conducting materials when doped and importantly employs the inexpensive and readily available monomer, acetylene gas. However, existing catalysts for the polymerization of acetylene do not permit their application in 3D printing of flexible electronic materials for the following reasons: 1) use of copious AlR₃ cocatalyst is required, 2) rates of polymerization do not allow for 3D printing, 3) catalysts loadings are too high and require extensive post-polymerization washing, 4) current catalysts produce predominantly cis-polyacetylene that requires thermal treating (150° C.) to isomerize to trans-polyacetylene, and 5) 3D printing from a gaseous monomer has yet to be developed. Further, linear polyacetylene is insoluble, cannot be melt processed, and therefore it is difficult to obtain morphologies that allow access of the electronic characteristics.

### SUMMARY

Provided herein are methods of preparing a three-dimensional article, comprising (a) depositing from a deposition means, a solution comprising a catalyst and a solvent on a substrate to form a printed design, (b) contacting the printed design with a gas comprising a plurality of monomers comprising alkynes, alkenes, or a combination thereof, thereby forming a first layer of solid polymer; and (c) advancing the substrate away from the deposition means to form the three dimensional article. In embodiments, the methods of the disclosure can include (d) repeating steps (a) to (c) once or more to forma second or further layer of solid polymer.

Further provided herein are apparatus for forming a three-dimensional object, including a vessel, the vessel containing a substrate and a deposition means configured to deposit a solution comprising a catalyst and a solvent on the substrate, and at least one controller operatively associated with the deposition means and the substrate for advancing the substrate away from the deposition means, wherein the vessel comprises a gas inlet and a gas outlet, the gas inlet operatively coupled to a gas source to introduce a gas comprising a plurality of monomers to the vessel, such that when the plurality of monomers is contacted with the catalyst, the monomers polymerize to form a polymer that makes up at least a portion of the three-dimensional object.

Further provided herein are articles comprising a plurality of stacked layers formed from cyclic polyacetylene, the layers being coupled to one another in the z-direction, wherein the cyclic polyacetylene comprises from about 75% to about 100% trans-polyacetylene, based on the total number of double bonds in the polyacetylene.

Further aspects and advantages will be apparent to those of ordinary skill in the art from a review of the following detailed descriptions. While the methods, apparatus, and articles are susceptible of embodiments in various forms, the description hereafter includes specific embodiments with the understanding that the disclosure is illustrative, and is not intended to limit the invention to the specific embodiments described herein.

### BRIEF DESCRIPTION OF THE DRAWINGS

For further facilitating the understanding of the present invention 2 drawing figures are appended hereto.

FIG. 1 is a schematic view of one embodiment of an apparatus useful for carrying out a method as disclosed herein.

FIG. 2 is a schematic view of one embodiment of an apparatus useful for carrying out a method as disclosed herein.

FIG. 3 is a simplified schematic of the printing process.

### DETAILED DESCRIPTION

Provided herein are methods and apparatus of forming a three-dimensional (3D) object. 3D layered gaseous deposition (LGD) as disclosed herein is unprecedented. While the disclosure describes 3D LGD for polyacetylene from gaseous acetylene monomers in detail, it will be apparent that the methods and apparatus are not limited to those including gaseous acetylene and polyacetylene. Advantageously, the LGD methods disclosed herein can utilize any gas phase monomer including a polymerizable double bond, as described in further detail herein. The LGD methods disclosed herein are particularly advantageous for polyacetylene prepared from acetylene monomers in view of the known limitations on processing polyacetylene. For example, due to its inherent solubility and lack of a melting point below its decomposition temperature, manufacturing of polyacetylene has been limited. 3D printed polyacetylene overcomes these limitations as the material is shaped in real time to the final product dimensions without the need for it to be soluble or in the melt state.

Advantageously, in contrast to known methods, some polymerization initiators/catalyst systems of the disclosure can produce cyclic polyacetylene (i.e., [N]annulene, wherein N is greater than 50) directly from gaseous acetylene without cocatalyst. Published recently is a report describing the highly efficient synthesis of cyclic-polyacetylene in its all-trans form and requiring only ppm catalyst loadings (Nature Chem, 2021, https://doi.org/10.1038/s41557-021-00713-2). Instantaneous polymerization occurs upon exposure of dilute solutions of transition metal catalysts described herein to 1 atm of acetylene. The cyclic topology of the polymer is an important feature because it renders the polymer nearly completely in the all-trans form and circumvents the need to heat-treat the polyacetylene to induce isomerization. The trans isomer of polyacetylene is advantageous because doped trans-polyacetylene has a higher conductivity than the doped cis isomer. The catalysts herein further demonstrated high activity, in terms of turnover frequency, for example, the initial rates for the turnover frequency can be 640,000 g/mol_{cat}/h. This means polymerization can occur instantaneous upon exposure to acetylene and permit, for the first time, the possibility of 3D printing polyacetylene. The 3D printing can further advantageously provide (semi-)conducting polymers that can be reliably reproduced in terms of electronic properties and magnetic properties, with well-defined dimensions, patterns, and dopant levels. The methods disclosed herein further provide a printed electrode, that can replace silver and gold electrode materials in printed electronics, with an improved sustainable footprint.

In some cases, the cyclic polyacetylene can be a trans-cyclic polyacetylene, wherein the cyclic polyacetylene has at least 75% trans double bonds and at least 50 polymerized monomer units. Unlike related linear polyacetylene, the cyclic polyacetylene disclosed herein can be synthesized at temperatures as low as −94° C. and still comprise at least 80%, e.g., at least 90%, at least 95%, or at least 99% or more trans double bonds. The cyclic polyacetylene disclosed herein can have low crosslinking defects, such as less than 5% or even less than 1%. The low crosslinking defects can be seen by the highly conjugated cyclic polyacetylene described herein, wherein the average conjugation length can be at least 100. The conductivity of the cyclic polyacetylene disclosed herein after doping is high, for example, the conductivity can be 341 ohm⁻¹cm⁻¹. Despite the large size of the cyclic polyacetylene as disclosed herein, it can be soluble in certain solutions for a period of time if held at low temperatures, e.g., 0° C., −20° C., or −78° C., unlike most linear polyacetylene. Cyclic polyacetylene that can be soluble is useful in industry for synthetic and processability purposes.

The trans-cyclic polyacetylene disclosed herein has low crosslinking defects. In embodiments, the trans-cyclic polyacetylene can have less than 5% crosslinking defects. For example, the trans-cyclic polyacetylene can have less than 5%, 4%, 3%, 2%, 1%, 0.5%, or 0.1% crosslinking defects. In embodiments, trans-cyclic polyacetylene can have less than 2% crosslinking defects. In embodiments, the trans-cyclic polyacetylene can have less than 1% crosslinking defects. As used herein, the term “crosslinking defects” is defined as a covalent bond(s) that joins two or more distinct cyclic polymers together or more than one covalent bond that joins a discrete cyclic polymer to itself.

In contrast, other catalyst technologies for preparing polyacetylene do not have efficiencies for producing polyacetylene directly from gaseous monomer and, further, produce cis-polyacetylene that must be thermally treated to obtain the desired trans form.

The use of the terms “a,” “an,” “the,” and similar referents in the context of the disclosure herein (especially in the context of the claims) are to be construed to cover both the singular and the plural, unless otherwise indicated. Recitation of ranges of values herein merely are intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended to better illustrate the disclosure herein and is not a limitation on the scope of the disclosure herein unless otherwise indicated. No language in the specification should be construed as indicating any non-claimed element as essential to the practice of the disclosure herein.

As used herein, the term “acetylene” refers to a compound having the structure of

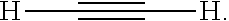

Polymerization Initiator/Catalyst system

In general, the polymerization initiator can be any catalyst that can polymerize a monomer having a polymerizable double bond, in the gas phase. Thus, in some embodiments, the catalyst comprises any catalyst known to polymerize an akene monomer such as ethylene or propylene. In some embodiments, the catalyst comprises any catalyst known to polymerize and alkyne monomer such as acetylene, propyne, 1-butane, 1-pentyne, 1-hexyne, and the like. In refinements of the foregoing embodiment, the catalyst can include, but is not limited to a metal-alkylidyne compound, a metallacycloalkylene compound, a metallacyclopropene compound, a metallacyclopentadiene compound, a metallacyclobutane compound or a combination thereof.

In embodiments, the catalyst can be a metallacycloalkylene compound. In some embodiments, the metallacycloalkylene compound can have a structure represented by Formula (I):

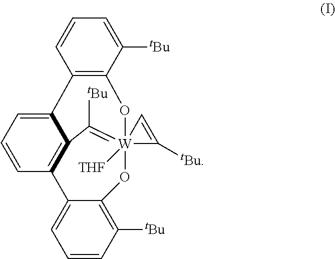

Methods of making and using the catalyst having a structure according to Formula (I) are described in U.S. Patent Application Publication No. 2020/0255560 A1 and PCT Application Publication No.s WO 2021/163533 A1 and WO 2020/223672 A1, which are all hereby incorporated by reference in their entirety.

In embodiments, the catalyst can be a metallacyclopropene compound. In some embodiments, the metallacyclopropene compound can have a structure represented by Formula (II):

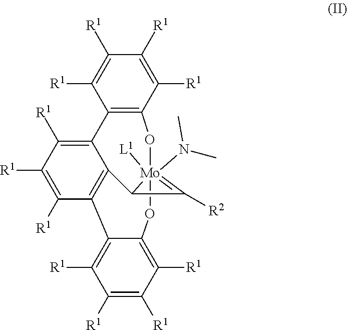

wherein each occurrence of R¹ is independently selected from H and C₁-C₆ alkyl, or two adjacent R¹ are linked to form a five- to eight-member cyclic group; R² is selected from Ar¹, C₁-C₂₂ alkyl, halo, C₁-C₂₂ haloalkyl, hydrogen, amino, alkoxy, ether, and (R³)₃—Si—; each occurrence of R³ is independently selected from C₁-C₂₂ alkyl, Ar¹, —O—(C1-C22 alkyl), —O—Ar¹, —N—(C1-C22 alkyl), or —N—Ar¹; Ar¹ is an aryl or heteroaryl group; and wherein L¹ is absent or selected from phosphine, amine, and five- or six-membered monocyclic groups containing 1 to 4 heteroatoms; provided that R² is not phenyl or (CH₃)₃—Si—. Methods of making and using the catalyst having a structure according to Formula (II) are described in U.S. Patent Application Publication No. 2020/0291051 A1 which is hereby incorporated by reference in its entirety.

In embodiments, the catalyst can be a metallacyclopentadiene compound. In some embodiments, the metallacyclopentadiene compound can have a structure represented by Formula (III) or Formula (IV):

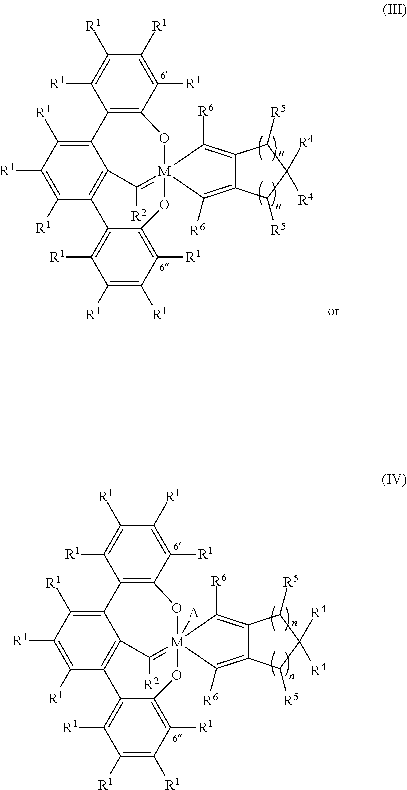

wherein M is a transition metal, each R¹ is independently H, C₁-C₂₀ alkyl, carboxyl, ester, amine, thiol, halo, C₁-C₂₂ haloalkyl, OH, or two adjacent R¹, together with the carbon atoms to which they are attached, form a five- to eight-member cyclic group; R² is selected from Ar¹, C₁-C₂₂ alkyl, halo, C₁-C₂₂ haloalkyl, hydrogen, —NH₂, —N—(C₁-C₂₂ alkyl)₂, —NH(C₁-C₂₂ alkyl), —NHAr¹, —NAr¹₂, —O—Ar¹, —O—(C₁-C₂₂ alkyl), and (R³)₃—Si—; each R⁴ is independently C₁-C₂₂ alkyl or both R⁴ together with the carbon atom to which they are attached form a spiro five- to eight-member monocyclic group or a spiro eleven- to thirty-member polycyclic group; each R⁵ is independently H, C₁-C₂₂ alkyl, —NH₂, —N—(C₁-C₂₂ alkyl)₂, —NH(C₁-C₂₂ alkyl), —OH, or —O—(C₁-C₂₂ alkyl); each n is independently 1, 2, 3, 4, or 5; each R⁶ is independently H, C₁-C₃ alkyl, halide, —NH₂, —N—(C₁-C₃ alkyl)₂, —NH(C₁-C₃ alkyl), —NHAr¹, —NAr¹₂, —O—Ar¹, —O—(C₁-C₃ alkyl), —S—Ar¹, —S—(C₁-C₃ alkyl); each R³ is independently selected from C₁-C₂₂ alkyl, Ar¹, —O—(C₁-C₂₂ alkyl), —O—Ar¹, —N—(C₁-C₂₂ alkyl)₂, —NH—(C₁-C₂₂ alkyl), —NH₂, —NH—Ar¹; —NAr¹², A is selected from the group consisting of NH₃, N(R⁷)₃, Ar², C₁-C₆ hydroxyalkyl, R⁷OR⁷, P(R⁷)₃, R⁷CHO, R⁷COR⁷, R⁷COOR⁷, and S(R⁷)₂, each Ar¹ and Ar² is independently an aryl or heteroaryl comprising 1 to 3 heteroatoms selected from O, N, and S, and each R⁷ is independently C₁-C₂ alkyl or Ar², or two R⁷, together with the atoms to which they are attached, form a five- to eight-member heterocycle. Methods of making and using the catalysts having a structure according to Formula (III) and Formula (IV) are described in PCT Application Publication No.s WO 2020/180843 A1 and WO 2020/223672 A1, the entirety of which are herein incorporated by reference.

In some embodiments, the catalyst can have a structure represented by Formula (V), Formula (VI), or Formula (VII):

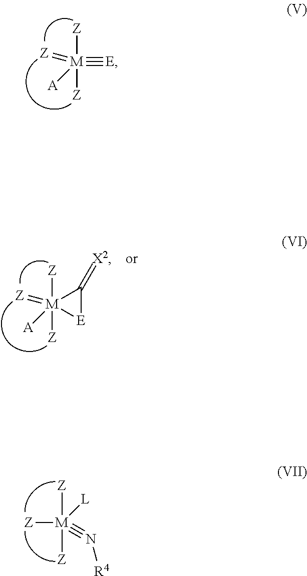

wherein M is a transition metal; A is selected from the group consisting of NH₃, N(R³)₃, Ar¹, C₁-C₆ hydroxyalkyl, R³OR³, P(R³)₃, R³CHO, R³COR³, R³COOR³, and S(R³)₂, each R³ is independently C₁-C₂₂ alkyl or Ar¹, or two R³, together with the atoms to which they are attached, form a five- to eight-member heterocycle; L is a ketene; E is NR⁴ or S, wherein R⁴ is C₁-C₂₂ alkyl or Ar¹; Z—Z—Z comprises a tridentate ligand having a structure of

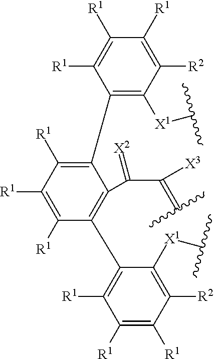

when the catalyst has a structure of Formula (V),

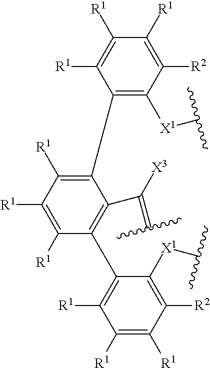

when the catalyst has a structure of Formula (VI), or

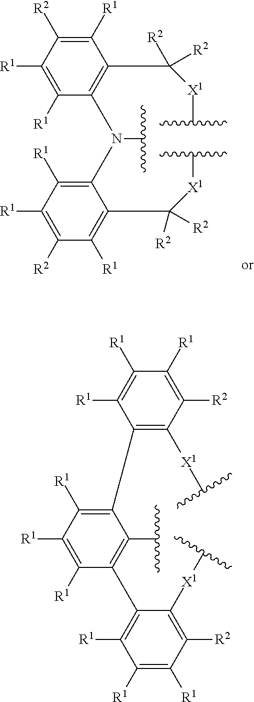

when the catalyst has a structure of formula (VII); each X¹ is independently O, NR⁵, or S, and R⁵ is C₁-C₂₂ alkyl, C₅-C₈cycloalkyl, or Ar¹; X² is O, NR⁶, or S, and R⁶ is C₁-C₂₂ alkyl, C₅-C₈cycloalkyl, or Ar¹; each R¹ is independently selected from H, C₁-C₂₂ alkyl, C₅-C₈cycloalkyl, carboxyl, ester, amino, thiol, halo, C₁-C₂₂ haloalkyl, and OH, or two adjacent R¹, together with the carbon atoms to which they are attached, can form a five- to eight-membered cyclic group; each R² is independently selected from H, Ar¹, C₁-C₂₂ alkyl, C₅-C₈cycloalkyl, halo, C₁-C₂₂ haloalkyl, —NH₂, —N—(C₁-C₂₂ alkyl)₂, —NH(C₁-C₂₂ alkyl), —NHAr¹, —NAr¹₂, —O—Ar¹, —O—(C₁-C₂₂ alkyl), and (R²)₃—Si—; X³ is selected from Ar¹, C₁-C₂₂ alkyl, C₅-C₈cycloalkyl, C₁-C₂₂ haloalkyl, and H; and each Ar¹ is independently selected from C₆-C₂₂ aryl or a 5-12 membered heteroaryl comprising from 1 to 3 ring heteroatoms selected from O, N, and S. Methods of making and using catalysts having a structure represented by Formula (V), Formula (VI), and Formula (VIII) are described in PCT Application Publication No. WO 2020/223426 A1.

In some embodiments, the catalyst can have a structure represented by Formula (VIII):

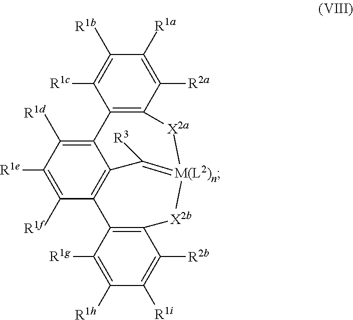

wherein M is a transition metal; each X^{2a} and X^{2b} is independently S, O, NR⁵ or PR⁶; each R^{1a}, R^{1b}, R^{1c}, R^{1d}, R^{1e}, R^{1f}, R^{1g}, R^{1h}, and R¹ⁱ is selected from H, C₁-C₂₁ alkyl, C₅-C₈cycloalkyl, Ar₁, carboxyl, C₁-C₂₂ ester, C₁-C₂₂ amino, C₁-C₂₂ thio, SH, halo, C₁-C₂₂ haloalkyl, C₁-C₂₀ alkoxy, and OH, or two vicinal R^{1a}, R^{1b}, R^{1c}, R^{1d}, R^{1e}, R^{1f}, R^{1g}, R^{1h}, or R¹ⁱ, together with the carbon atoms to which they are attached, form a five- to eight-member cycloalkyl, aryl, heteroaryl comprising 1 to 5 heteroatoms selected from O, N, and S, or heterocycloalkyl comprising 1 to 5 heteroatoms selected from O, N, and S; each R^{2a} and R^{2b} is selected from H, Ar¹, C₁-C₂₂ alkyl, C₅-C₈cycloalkyl, halogen, C₁-C₂₂ haloalkyl, C₁-C₂₂ amino, C₁-C₂₀ alkoxy, C₆-C₂₀ aryloxy, C₁-C₂₀ heteroaryloxy comprising 1 to 5 heteroatoms selected from O, N, and S, and (R⁷)₃—Si—; R⁴ is selected from C₁-C₂₂ alkyl, C₁-C₂₂ alkoxy, C₅-C₈cycloalkyl, carboxyl, ester, amino, thiol, halo, C₁-C₂₂ haloalkyl, C₂₂-C₂₀alkenyl, Ar¹, O—Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S; each L¹ is independently a ligand; each L² is independently a ligand; m is 0, 1, 2, 3, 4, or 5; and, n is 0, 1, 2, 3, or 4.

In embodiments, the catalyst can have a structure represented by one of the following formulas:

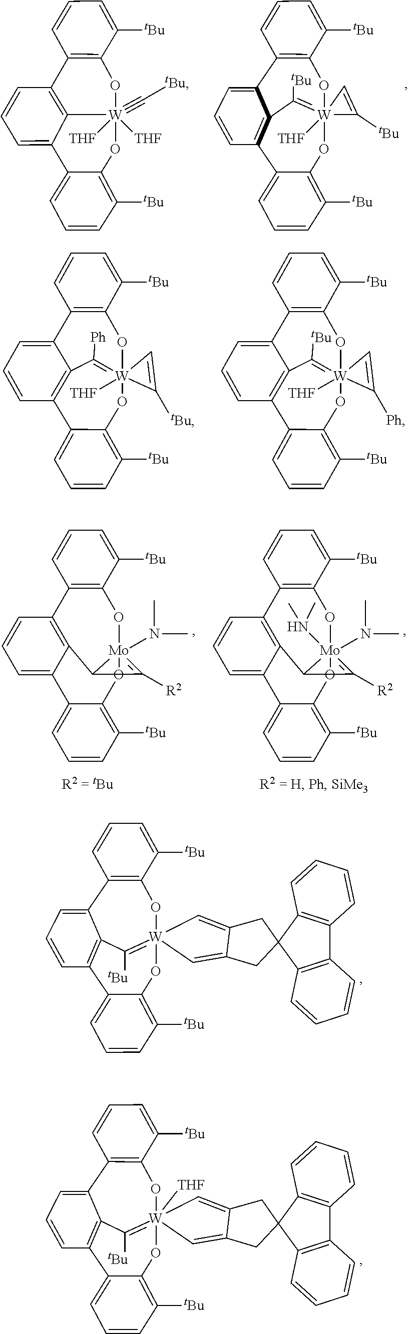

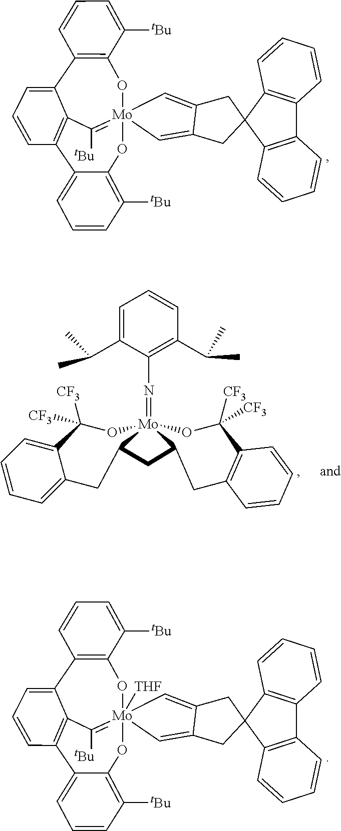

In general, the catalyst can be provided in a solution, the solution including the catalyst and a solvent. The solution including the catalyst can be free or substantially free of water and/or oxygen. As used herein and unless specified otherwise, the solution including the catalyst is substantially free of “oxygen and/or water” if the amount of oxygen or water in the solution is less about 500 ppm. For example, less than about 400 ppm, less than about 300 ppm, less than about 200 ppm, or less than about 100 ppm. Examples of solvents that may be used include organic solvents that are inert under the polymerization conditions. In embodiments, the solvent can be an aprotic solvent. In embodiments, the aprotic solvent can be aliphatic hydrocarbons, aromatic hydrocarbons, heteroaryls, ethers, halogenate hydrocarbons, or a combination thereof. For example, the aprotic solvent can be propylene glycol, dichloromethane, tetrahydrofuran, ethyl acetate, diethyl ether, 1,4-dioxane, chloroform, pentane, hexane, benzene, pyridine, toluene, acetone, dimethylformamide (DMF), or a combination thereof. In embodiments, the solvent can be selected from the group of propylene glycol, dichloromethane, tetrahydrofuran, ethyl acetate, diethyl ether, 1,4-dioxane, chloroform, pentane, hexane, benzene, pyridine, toluene, acetone, dimethylformamide (DMF), or a combination thereof.

For example, the catalyst is provided in the solution at a concentration of 0.001 μg of catalyst per mL of solvent (mg/mL) to 100 mg/mL, 0.01 μg/mL to 100 mg/mL, 0.1 μg/mL to 100 mg/mL, 0.5 μg/mL to 100 mg/mL, 1 μg/mL to 100 mg/mL, 10 μg/mL to 100 mg/mL, 50 μg/mL to 100 mg/mL, or 0.1 mg/mL to 75 mg/mL, or 0.1 mg/mL to 50 mg/mL, or 0.5 mg/mL to 50 mg/mL, or 1 mg/mL to 50 mg/mL, or 1 mg/mL to 25 mg/mL, or 0.1 mg/mL to 25 mg/mL, or 1 mg/mL to 10 mg/mL. Without intending to be bound by theory, it is believed that as the concentration of catalyst in the solvent increases, the risk of undesirable agglomeration during deposition (e.g., clogging of a nozzle) increases. In embodiments, the solution including the catalyst can be a shear-thinning solution.

The solvent can be selected to provide even spreading and subsequent drying of the catalyst solution. Solvent properties such as dynamic viscosity, surface tension, catalyst solubility, and stability at low catalyst concentration (e.g., 1-100 ppm) can affect the uniform spreading and drying of the catalyst solution. Thus, in some embodiments, the solvent can be characterized by a viscosity of at least 10 mPa·s, a surface tension below 40 mN·m, or both. Solvents characterized by such viscosities and surface tensions can enable high resolution deposition.

### Monomers

In general, the plurality of monomers can include any monomer that can be provided in the gas phase, including as the vapor of a liquid monomer, and has a polymerizable double or triple bond. The plurality of monomers generally does not include photopolymerizable monomers. In embodiments, the plurality of monomers can include alkynes, alkenes, or a combination thereof. In embodiments the plurality of monomers includes a plurality of alkynes. In refinements of the foregoing embodiment, the plurality of alkynes can include a sole monomer type, i.e., the plurality of alkynes comprises the same alkyne. In another refinement of the foregoing embodiment, the plurality of alkynes can include a mixture of monomers, i.e., the plurality of alkynes comprises a mixture of different alkynes. In embodiments, the plurality of monomers comprises a plurality of alkanes, wherein the alkanes can be the same or different.

Examples of monomers suitable for use in the methods disclosed herein include, but are not limited to, acetylene, propyne, 1-butyne, 1-pentyne, 1-hexyne, ethylene, propylene, and a combination thereof. In embodiments, the plurality of monomers comprises acetylene, propyne, 1-butane, 1-pentyne, 1-hexyne, or a combination thereof. In embodiments, the plurality of monomers comprises ethylene, propylene, or a combination thereof.

In general, upon contact of the phase monomer with the catalyst solution, polymerization occurs resulting in the precipitation of a solid polymer. However, in some embodiments, upon the contacting of the gaseous monomer and the catalyst solution the polymer product formed can be temporarily soluble in the combined solution. As used herein, and unless specified otherwise, the term “temporarily soluble” refers to a material being soluble in a given solution and at a given temperature for at least one minute before precipitating from the solution. For example, a trans-cyclic polyacetylene product formed can be soluble in the combined solution for at least 1 minute. In embodiments, the trans-cyclic polyacetylene product formed can be soluble in the combined solutions for 1 minute to 10 minutes, or 1 minutes to 5 minutes, or 1 minutes to 3 minutes, such as, 1 minute, 1 minutes, or 3 minutes. As used herein and unless specified otherwise, the phrase “solid polymer” includes a polymer in the solid state in accordance with the ordinary meaning in the art, and further encompasses a polymer in the “temporarily soluble” state, prior to precipitation.

The concentration of the plurality of monomers in the gas that is contacted with the catalyst solution can be in a range of about 1 mol % to about 100 mol %, based on the total moles of gas. In embodiments, the concentration of the monomers can be in a range of about 1 mol % to about 99.9 mol %, about 1 mol % to about 99.5 mol %, about 1 mol % to about 99 mol %, about 1 mol % to about 95 mol %, about 1 mol % to about 90 mol %, about 1 mol % to about 75 mol %, about 5 mol % to about 75 mol %, about 10 mol % to about 70 mol %, about 10 mol % to about 60 mol %, about 15 mol % to about 50 mol %, or about 25 mol % to about 50 mol %. In embodiments wherein the concentration of the monomers in the gas is less than 100%, the balance of the gas can include an aprotic solvent, an inert gas, or a combination thereof. In embodiments, the aprotic solvent can include an aliphatic hydrocarbon, an aromatic hydrocarbon, a heteroaryl, an ether, a ketone, an amide, a halogenated hydrocarbon, or a combination thereof. In embodiments, the aprotic solvent comprises, acetone, dimethylformamide, dichloromethane, tetrahydrofuran, ethyl acetate, diethyl ether, 1,4-dioxane, chloroform, pentane, hexane, benzene, pyridine, toluene, or a combination thereof. In embodiments, the inert gas comprises N₂, Ar, Ne, Kr, Xe, or a combination thereof. Thus, in some embodiments the contacting of the plurality of monomers and catalyst solution takes place in an inert atmosphere. When an inert gas is included in the gas that is contacted with the catalyst solution, the inert gas can be pre-mixed with the gaseous monomer such that both are dispensed from a single nozzle into the polymerization apparatus. In some embodiments, the inert gas and the gaseous monomer are provided from two separate sources using two or more nozzles such that upon entering the polymerization apparatus, the two gases form an admixture that contacts the catalyst solution, the admixture having a concentration of monomers as described above.

Generation of uniform cyclicpolyalkyne films depends on the reaction kinetics and the presence of a steady-state concentration of monomer that remains unchanged as the printed object is generated. For generic gaseous alkyne or alkene monomers, the steady-state concentration of monomer can be modulated by premixing the gaseous monomer(s) with an inert carrier gas in desired proportions. Time-course dependent formation of cyclicpolyalkyne film thickness and roughness can be assessed via atomic forct microscopy (AFM) and stylus profilometry.

In embodiments wherein the polymer product formed can be temporarily soluble in the combined solutions, the gaseous monomer can be dilute and/or the catalyst solution can be dilute. In embodiments, the polymer product formed can be soluble in the combined solution for at least one minute, when the temperature of the combined solutions is −50° C. or higher, such as, −40° C., −30° C., −20° C., −10° C., 0° C., 10° C., 20° C., 25° C., 30° C. or higher, 50° C. or higher, 75° C. or higher, or 100° C. or higher. In embodiments, the polymer product formed can be temporarily soluble at a temperature of about −20° C. or higher. In embodiments, the polymer product formed can be soluble in the combined solution for 1 minute to 10 minutes, or 1 minutes to 5 minutes, or 1 minutes to 3 minutes, such as, 1 minute, 1 minutes, or 3 minutes, when the temperature of the combined solution is −50° C. or higher, such as, −40° C., −30° C., −20° C., −10° C., 0° C., 10° C., 20° C., 25° C., 30° C. or higher, 50° C. or higher, 75° C. or higher, or 100° C. or higher.

Methods of confirming the presence of cyclic polymers as well as determining the presence and amounts of trans-double bonds are known in the art and are described, for example, in PCT Publication No. WO 2021/163533 A1, herein incorporated by reference in its entirety. Methods of determining the conductivity of a polymer can be found in the same reference.

### Dopant

In some embodiments, the polymers can further comprise a dopant. In embodiments, the dopant can be a p-type dopant or n-type dopant. In embodiments, the dopant can be bromine, iodine, chlorine, inter halogens (e.g., ICI, IBr) AsF₅, SbF₆, SbCl₆, HClO₄, H₂SO₄, (NO)(PF₆), Ag(ClO₄), lithium, sodium, potassium, N-dimethylbenzimadazoline (N-DMBI), Mo((SCH)₂)₃, CoCp₂, NOPF₆, or a combination thereof. For example, the can be provided to improve the electrical conductivity of the polymer. In embodiments, the dopant can improve the conductivity of the polymer by orders of magnitude. In some embodiments, the dopant comprises a p-type dopant and the p-type dopant comprises Br₂, I₂, Cl₂, AsF₅, Mo((SCH)₂)₃, or a combination thereof. In some embodiments, the dopant comprises a n-type dopant and the n-type dopant comprises lithium, sodium, potassium, N-dimethylbenzimadazoline (N-DMBI), or a combination thereof.

The dopant can be provided to the polymer by contacting the solution of the catalyst, solid polymer, or both, to a dopant. In some embodiments, the dopant is provided to the solution of the catalyst prior to contacting the catalyst with the gaseous monomer. In some embodiments, the dopant is provided to the solution of catalyst concurrently with the contacting of the catalyst to the gaseous monomer. In some embodiments, e.g., wherein the polymer can be temporarily soluble after contacting the gaseous monomer with the catalyst solution, the dopant can be provided after the contacting of the catalyst to the gaseous monomer.

In embodiments wherein the polymer is doped with a dopant, the polymer can have a conductivity of at least 10 ohm⁻¹cm⁻¹. In embodiments, the polymer can have a conductivity of at least 100 ohm⁻¹cm⁻¹. In embodiments, the polymer can have a conductivity of at least 200 ohm⁻¹ cm⁻¹. In embodiments, the polymer can have a conductivity of at least 300 ohm⁻¹cm⁻¹. For example, the polymer can have a conductivity of at least 100 ohm⁻¹cm⁻¹, such as 100 ohm⁻¹cm⁻¹, 150 ohm⁻¹cm⁻¹, 200 ohm⁻¹cm⁻¹, 250 ohm⁻¹cm⁻¹, 300 ohm⁻¹cm⁻¹, 320 ohm⁻¹cm⁻¹, 340 ohm⁻¹cm⁻¹, or 350 ohm⁻¹cm⁻¹ or more. In some cases, the conductivity can be to up 10,000 ohm⁻¹cm⁻¹. In embodiments, a trans-cyclic polyacetylene can have a conductivity of at least 100 ohm⁻¹cm⁻¹, such as 100 ohm⁻¹cm⁻¹, 150 ohm⁻¹cm⁻¹, 200 ohm⁻¹cm⁻¹, 250 ohm⁻¹cm⁻¹, 300 ohm⁻¹cm⁻¹, 320 ohm⁻¹ cm⁻¹, 340 ohm⁻¹cm⁻¹, or 350 ohm⁻¹cm⁻¹ or more and, in some cases, the conductivity can be to up 10,000 ohm⁻¹cm⁻¹.

### Additional Materials

Additional materials can be added to the printed, solid polymer to modify the physical and/or chemical properties of the solid material and/or to provide additional functionality to the solid polymer. In embodiments, the methods of the disclosure can include contacting the solid polymer with an additional material selected from the group of an oxygen impermeable material, a material to saturate a double bond of the printed polymer, a second or further polymer material, a metal, and a combination thereof. In some embodiments, the additional material can include an oxygen impermeable material selected from the group of polyvinylidene chloride (PVDC), ethylene vinyl alcohol (EVOH), polyamide (nylon), polyolefins, and a combination thereof. In embodiments, the additional material can include a material to saturate a double bond of the polymer, the material selected from the group of comprising Br₂, Cl₂, HCl, H₂, and a combination thereof. In embodiments, the additional material can include a second polymer material selected from the group of polyacrylic acid, acrylonitrile butadiene styrene, polyvinyl alcohol plastic, polycarbonate, or a combination thereof. In embodiments, the additional material can include a metal selected from the group of silver, gold, and a combination thereof.

### Substrates

In general, the substrate can be any substrate that can support the 3D printed object during printing. As described in further detail below, the substrate can be or can be on a stationary or moveable platform, or a surface of the vessel. In embodiments, the substrate can be or can be on a linear translation stage, also referred to herein as a mobile stage, that can be controlled to aid in the controlled deposition of the solution of the catalyst. In embodiments, the substrate can include a metal, a polymer, silicon, a plastic, wood, glass, or a combination thereof. In embodiments, the substrate can be an electric device, a battery, a solar cell, or a sensor. For example, the substrate can be an organic solar cell, an electronic circuit, an organic light-emitting diodes, a transistor, an actuator, a supercapacitor, a chemical sensor and/or biosensor, a flexible transparent display, or the like. In embodiments, 3D printed object can be free-standing on the substrate. As used herein, the term “free-standing” refers to the object not being bound to the substrate. In some embodiments, the 3D printed object can be bound to the substrate.

### Methods of the Disclosure

In general, the disclosure provides methods of preparing a three-dimensional (3D) article or object by layered gaseous deposition (LGD). In embodiments, once the gaseous monomer and solution including the catalyst are supplied together in a suitable apparatus, fabrication of the three dimensional object may commence. Fabrication may be carried out layer-by-layer or continuously. The methods of the disclosure can include the steps of:
(a) depositing, from a deposition means, a solution including a catalyst and a solvent on a substrate to form a printed design;
(b) contacting the printed design with a gas comprising a plurality of monomers comprising alkynes, alkenes, or a combination thereof, thereby forming a first layer of solid polymer; and
(c) advancing the substrate away from the deposition means to form the three-dimensional article.

The methods of the disclosure can optionally further include (d) repeating steps (a) to (c) to form a second or further layer of solid polymer. In embodiments wherein steps (a) to (c) are repeated at least once, in the second and further iterations of steps (a) to (c), the substrate can comprise the at least a portion of the previously deposited solid polymer layers. That is, a second or further layer of polymer can be printed on the first or further layers of polymer to grow the article in the z-direction, relative to the substrate. Thus, in embodiments, at least a portion of the second layer of solid polymer is formed in contact with the first layer of solid polymer such that stacked layers are formed in the z-direction, relative to the substrate. Steps (a)-(c) can be repeated as many times as necessary to provide a fully printed article.

In embodiments, the contacting of the printed design with the gas comprises introducing the gas into a closed container including the printed design. Thus, in some embodiments, the printed design is deposited on the substrate prior to introducing the gas to the closed container.

In embodiments, contacting the printed design with the gas comprises introducing the gas into a closed container followed by deposition of the printed design. Thus in embodiments, the contacting the printed design with the gas includes depositing the printed design into a closed container including the gas.

In some embodiments, the contacting the printed design with the gas includes depositing the printed design concurrently with introducing the gas comprising the plurality of monomers to a closed container comprising the deposition means and the substrate.

The closed container can be filled with the gas including the plurality of monomers in bulk, or the closed container can have an atmosphere of an inert gas and the gas comprising the plurality of monomers can be selectively introduced to an area of the container proximate to the printed design, for example through a nozzle directed at the substrate.

The concentration of the plurality of monomers in the gas comprising the plurality of monomers and the concentration of the catalyst in the solution including the catalyst can be any suitable range previously disclosed herein for these concentrations. In embodiments, the contacting of the gas comprising the plurality of monomers and the printed design can take place at a pressure of about 1 atmosphere (about 101 kPa) and a temperature of about −100° C. to about 200° C., about −100° C. to about 20° C., about −75° C. to about 1° C., about −50° C. to about 1° C., about −25° C. to about 1° C., about 20° C. to about 200° C., about 20° C. to about 150° C., about 20° C. to about 125° C., about 20° C. to about 100° C., about 25° C. to about 80° C., about 25° C. to about 75° C., about 25° C. to about 50° C., or about 20° C. to about 35° C. In embodiments, the contacting of the gas comprising the plurality of monomers and the printed design can take place at a pressure of about 1 kPa to about 200 kPa, about 10 kPa to about 200 kPa, about 25 kPa to about 200 kPa, about 50 kPa to about 200 kPa, about 75 kPa to about 200 kPa, or about 100 kPa to about 200 kPa at ambient temperature (about 20-25° C.).

In embodiments, the contacting of the gas comprising the plurality of monomers and the printed design can include flowing the gas over the printed design. In embodiments, contacting of the gas comprising the plurality of monomers and the printed design can include flowing the gas over the printed designed at a flow rate of about 0.5 mL/min to about 1000 mL/min, for example, about 1.0 mL/min to about 900 mL/min, about 2.5 mL/min to about 750 mL/min, about 5 mL/min to about 500 mL/min, about 10 mL/min to about 250 mL/min, about 15 mL/min to about 100 mL/min, or about 20 mL/min to about 80 mL/min.

In some embodiments, the contacting of the gas comprising the plurality of monomers and the printed design can include charging the closed container with the gas to a pressure of about 100 kPa. In embodiments, the gas comprising the plurality of monomers consists of the plurality of monomers. In embodiments, the gas comprising the plurality of monomers comprises the monomers and an inert gas, wherein the inert gas is selected from those disclosed herein. In embodiments, the gas comprising the plurality of monomers comprises the monomers and a solvent, wherein the solvent is selected from those disclosed herein. In embodiments, the gas comprising the plurality of monomers comprises the monomers, a solvent, wherein the solvent is selected from those disclosed herein, and an inert gas, wherein the inert gas is selected from those disclosed herein.

The methods of the disclosure can optionally further comprise (e) purging the closed container of the gas including the plurality of monomers using an inert gas. The inert gas can be selected from the group of N₂, Ar, Kr, Ne, Xe, and a combination thereof. Optionally, step (e) is performed after step (b) and before step (d). In embodiments, step (e) occurs prior to step (c). In embodiments, step (e) occurs after step (c). In embodiments, step (e) occurs concurrently with step (c).

Optionally, the methods disclosed herein can further include contacting the solution of catalyst, solid polymer, or both to a dopant. In embodiments, the dopant is provided in the solution of catalyst. In embodiments, the dopant is provided through a deposition means, for example, a nozzle proximate to the substrate.

Optionally, the methods disclosed herein can further include contacting the solid polymer with an additional material, wherein the additional material can include an oxygen impermeable material, a material to saturate a double bond of an unsaturated polymer, a second polymer material, a metal or a combination thereof. The additional material can be provided to each layer of printed polymer (i.e., between steps (b) of one iteration of the method and (a) of a second iteration of the method) or can be applied to the entire three-dimensional object after forming multiple layers of printed polymer. The additional material can be provided to the solid polymer, for example, by depositing the additional material from a deposition means to the printed polymer on the substrate. In addition, or in the alternative, the additional material can be provided to the solid polymer outside the closed container using any suitable means such as dip coating, spray coating, or the like.

In some embodiments, the advancing step is carried out sequentially in uniform increments for each step or increment. In some embodiments, the advancing step is carried out sequentially in variable increments for each step or increment. The size of the increment, along with the rate of advancing, will depend in part upon factors such as temperature, pressure, structure of the article being produced (e.g., size, density, complexity, configuration, etc.).

In other embodiments of the invention, the advancing step is carried out continuously, at a uniform or variable rate. Note that fabrication of the product may be continuous (as opposed to layer-by-layer) even when the advancing step is carried out in increments.

In some embodiments, the rate of advance (whether carried out sequentially or continuously) is from about 0.1, 1, or 10 microns per second, up to about to 100, 1,000, or 10,000 microns per second, again depending again depending on factors such as temperature, pressure, structure of the article being produced, intensity of radiation, etc. In embodiments, the substrate and, thereby, the print, can be retracted away from the build surface at a constant rate, for example, about 0.001 micron, about 0.01 micron, about 0.05 micron, about 0.1 micron, about 1 micron, about 5 microns, about 10 microns, or about 30 microns per second up to about 200 microns, about 180 microns, about 160 microns, about 140 microns, or about 120 microns per second, thereby advancing the substrate away from the deposition means at a constant rate. In embodiments, the print is retracted away from the deposition means at a constant rate.

Advancing the substrate away from deposition means can include (a) advancing the substrate away from a stationary deposition means, or (b) advancing the deposition means away from a stationary substrate, or (c) a combination of advancing the substrate away from the deposition means and advancing the deposition means away from the substrate. In some embodiments, advancing the substrate away from the deposition means can be at a constant rate for a fixed distance and is then paused for a fixed amount of time, and optionally repeated. In some cases, advancing the substrate away from the deposition means can include advancing the substrate away from the deposition means at a variable rate for a fixed distance and is then paused for a fixed amount of time, and optionally repeated. The cycle of advancing the substrate away from the deposition means for a fixed distance followed by a pause for a fixed amount of time can provide an effective retraction rate (the total retraction displacement over the full time of the pull-pause cycle) of about 0.001 microns per second to about 100 microns per second, about 0.01 microns per second to about 500 microns per second, or about 0.1 microns per second to about 10 microns per second.

In embodiments, the deposition means for depositing the solution of catalyst or additional materials can be any means suitable for depositing the solution of catalyst or additional materials in a controlled fashion. An example of a suitable deposition means can include a nozzle fluidly connected (e.g., with a tube/hose) to a reservoir containing the solution of catalyst or additional materials, wherein the nozzle or hose is operatively connected to a controller for controlling the deposition of the solution of catalyst or additional material. Other suitable deposition means include printers, such as an ink jet printer. The deposition means can have a one way valve such that the gas does not move into the catalyst solution tube/hose to the reservoir.

The solution of catalyst can be extruded through a nozzle or a printer at any suitable rate, for example in a range of about 0.01 mL/s to about 50 mL/s, about 0.05 mL/s to about 45 mL/s, about 0.1 mL/s to about 40 mL/s, about 0.5 mL/s to about 35 mL/s, about 1 mL/s to about 30 mL/s, or about 2.5 mL/s to about 25 mL/s.

The method of 3D printing herein can have a high rate of polymerization, such as an initial turnover frequency of 620,000 g/mol_{cat}/h. For example, in embodiments, the catalyst having the structure of formula (I) can have an initial turnover frequency of at least 640,000 g/mol_{cat}/h, or at least 200,000 g/mol_{cat}/h. For example, the catalyst having the structure of formula (I) has an initial turnover frequency of 200,000 g/mol_{cat}/h to 700,000 g/mol_{cat}/h, or 300,000 g/mol_{cat}/h to 650,000 g/mol_{cat}/h, or 400,000 g/mol_{cat}/h to 700,000 g/mol_{cat}/h, such as 200,000 g/mol_{cat}/h, 250,000 g/mol_{cat}/h, 300,000 g/mol_{cat}/h, 400,000 g/mol_{cat}/h, 500,000 g/mol_{cat}/h, 600,000 g/mol_{cat}/h, or 620,000 g/mol_{cat}/h.

The methods disclosed herein can further include filtering, cleaning, decontaminating and/or reclaiming the gas including the plurality of monomers and/or a purge gas.

### Apparatus for Forming 3D Objects

The disclosure provides a new method of 3D printing that employs layered gaseous deposition (LGD). The methods of the disclosure can be implemented with a variety of different apparatus. The disclosure provides apparatus for forming a three-dimensional object, the apparatus including a vessel, wherein the vessel contains a substrate and a deposition means configured to deposit a solution comprising a catalyst and a solvent on the substrate, and at least one controller (e.g., a computer with appropriate interface and program) operatively associated with the deposition means and the substrate for advancing the substrate away from the deposition means, wherein the vessel comprises a gas inlet and a gas outlet, the gas inlet operatively coupled to a gas source to introduce a gas comprising a plurality of monomers to the vessel, such that when the plurality of monomers is contacted with the catalyst, the monomers polymerize to form a polymer that makes up at least a portion of the three-dimensional object.

The vessel can generally be any vessel that can contain the substrate and the deposition means, that can be closed off to the surrounding environment, and which can optionally withstand being pressurized or evacuated. Additionally, suitable vessels should not be oxygen permeable, such that the vessel transmits less than 5% by volume, less than 3% by volume, or less than 1% by volume of the oxygen contained in the exterior atmosphere to which the vessel is exposed. Suitable vessels can be prepared of glass, low-iron and high-transparence glass variants (commercially referred to as sapphire glass, quartz, sapphire, soda lime acrylic, fused silica, fused quartz, germanium, borosilicate, silicon nitride, or combinations thereof.

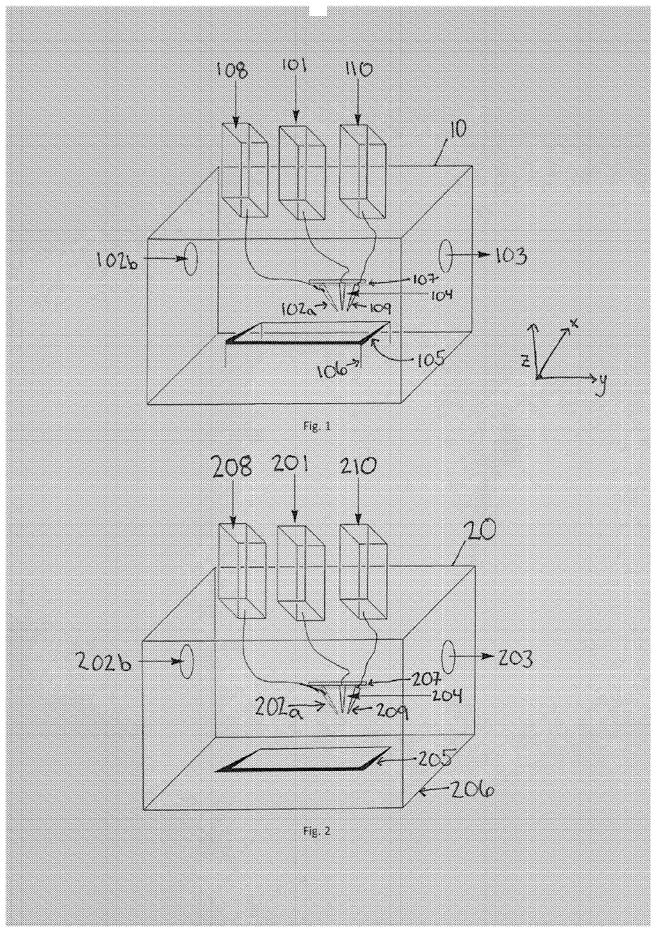

FIG. 1 provides schematic view of one embodiment of an apparatus useful for carrying out a method as disclosed herein. With reference to FIG. 1, the apparatus can include a vessel 10 that is a closed container including a deposition means 104 and a substrate 105. The deposition means 104 is fluidly connected to a catalyst solution reservoir 101 which includes the solution including the catalyst (not shown). The deposition means 104 and catalyst solution 101 can be operatively associated with a controller (not shown) in order to control the flow rate of the catalyst solution to the substrate 105. The substrate 105 can be operatively associated with an actuator (not shown), and the actuator operatively associated with a controller (not shown) to allow moving of the substrate in an x-y plane defined by the bottom of the vessel. The deposition means 104 can be operatively associated with an actuator 107, and the actuator operatively associated with a controller (not shown) to allow moving of the deposition means in an x-y plan defined by the bottom of the vessel and/or in a z-direction normal to the x-y plane for advancing the substrate away from the deposition means. The substrate 105 can, in embodiments, be attached to an actuator or other means such as adjustable legs 106 that are operatively associated with a controller to advance the substrate away from the deposition means. The vessel can further include a gas inlet 102a1102b and a gas outlet 103. The gas inlet 102a can, for example, take the form of a nozzle fluidly connected to a gas source/reservoir 108 including the gas including the plurality of monomers, which are operatively associated with a controller (not shown) in order to control the flow rate of the gas including the plurality of monomers to the substrate 105 and the pressure inside the vessel. The vessel can further include a second gas inlet 102b for providing a purge gas from a reservoir (not shown). The gas outlet 103 can be used to purge the gas containing the plurality of monomers and/or the purge gas from the vessel. In an alternative arrangement, gas inlet 102b can be used to provide a gas including the plurality of monomer to the bulk of the vessel in combination with or in the alternative to gas inlet 102a, and the gas entering at gas inlet 102b can include a mixture of the plurality of monomer and an inert gas provided from a common source or combined before entering the vessel (not shown). A controller (not shown) can be operatively associated with the gas inlet 102b to control the flow of gas into the vessel and the pressure within the vessel. The gas outlet 103 can be operatively associated with a controller to control the pressure within the vessel. The apparatus can further include an additional inlet 109 configured to introduce an additional material to the vessel from a reservoir 110, which can be operatively associated with a controller (not shown) to control the introduction of the additional material to the vessel.

FIG. 2 provides schematic view of one embodiment of an apparatus useful for carrying out a method as disclosed herein. With reference to FIG. 2, the apparatus can include a vessel 20 that is a closed container including a deposition means 204 and a substrate 205. The deposition means 204 is fluidly associated with a catalyst solution reservoir 201 which includes the solution including the catalyst (not shown). The deposition means 204 and catalyst solution 201 can be operatively associated with a controller (not shown) in order to control the flow rate of the catalyst solution to the substrate 205. The deposition means 204 can be operatively associated with an actuator 207, and the actuator operatively associated with a controller (not shown) to allow moving of the deposition means in an x-y plan defined by the bottom of the vessel and/or in a z-direction normal to the x-y plane for advancing the substrate away from the deposition means. The substrate 205 can, in embodiments, be on or be a portion of the bottom of the vessel 206. The vessel can further include a gas inlet 202a/202b and a gas outlet 203. The gas inlet 202a can, for example, take the form of a nozzle fluidly connected to a gas source/reservoir 208 including the gas including the plurality of monomers, which are operatively associated with a controller (not shown) in order to control the flow rate of the gas including the plurality of monomers to the substrate 205 and the pressure inside the vessel. The vessel can further include a second gas inlet 202b for providing a purge gas from a reservoir (not shown). The gas outlet 203 can be used to purge the gas containing the plurality of monomers and/or the purge gas from the vessel. In an alternative arrangement, gas inlet 102b can be used to provide a gas including the plurality of monomer to the bulk of the vessel in combination with or in the alternative to gas inlet 202a, and the gas entering at gas inlet 202b can include a mixture of the plurality of monomer and an inert gas provided from a common source or combined before entering the vessel (not shown). A controller (not shown) can be operatively associated with the gas inlet 202b to control the flow of gas into the vessel and the pressure within the vessel. The gas outlet 203 can be operatively associated with a controller to control the pressure within the vessel. The apparatus can further include an additional inlet 209 configured to introduce an additional material to the vessel from a reservoir 210, which can be operatively associated with a controller (not shown) to control the introduction of the additional material to the vessel.

The controllers referenced in the descriptions of FIG. 1 and FIG. 2 can be the same controller, such that the controller is operatively associated to the gas inlet, gas source/reservoir, gas outlet or a combination thereof. In embodiments, the gas inlet can be in fluid communication with the gas outlet to provide a flow of gas across the vessel. In embodiments, the gas outlet can be in fluid communication with the gas inlet to provide recirculation of the gas along the closed loop. In refinements of the foregoing embodiment, the gas source including the plurality of monomers can be located along the closed loop.

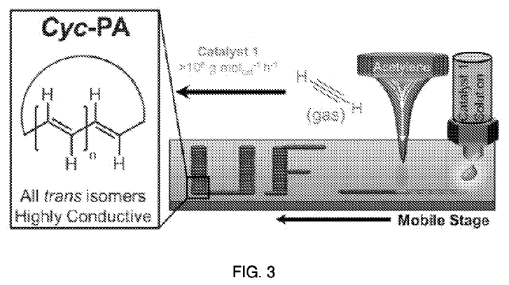

FIGS. 1 and 2 represent two of the simpler apparatus of the disclosure. Numerous variations on the apparatus described in FIGS. 1 and 2 above can be employed. FIG. 3 is a simplified schematic of the process of printing cyclic polyacetylene.

In embodiments, the apparatus can optionally include a scrubber or a reclamation chamber fluidly connected with the gas outlet. In embodiments, the apparatus includes a scrubber for filtering, cleaning, and/or decontaminating the gas including the plurality of monomers and/or a purge gas as it exits the gas outlet. In embodiments, the apparatus further includes a reclamation chamber for recapturing the plurality of monomers that were not used in the polymerization of the solid polymer and/or the inert gas used to purge the vessel. In embodiments, a scrubber can be provided between the gas source/reservoir and the vessel to filter, clean, and/or decontaminate the plurality of monomers prior to the introduction of the monomers to the vessel. For example, commercially available monomers may be provided with a solvent and the scrubber can be used to remove the solvent from the monomer prior to introducing the monomer to the vessel.

In embodiments, the apparatus can optionally include a dopant inlet configured to introduce a dopant to the vessel, the dopant inlet operatively coupled to a dopant source. In embodiments, the apparatus can be configured to introduce the dopant to the vessel concurrently with the introduction of the gas comprising the plurality of monomers.

In embodiments, the deposition means can be a nozzle or a plurality of nozzles in fluid communication with a catalyst source and configured to deliver the solution of the catalyst to the substrate. In embodiments, the deposition means can be a bipolar piezo waveform that can maximize the spatial control and deposition uniformity of the deposited catalyst. The nozzle or plurality of nozzles can be operatively coupled to a controller such as a computer with appropriate interface and program to provide instructions for depositing a controlled amount of catalyst solutions in a desired design, to form a printed design. The printed design can be any design. In embodiments, the design is not a continuous film. In some embodiments, the design can be a repeating pattern.

The apparatus can further include a heating and/or cooling element to measure and control the temperature inside the vessel.

In embodiments, the apparatus is configured to deposit the solution comprising the catalyst and the solvent on the substrate concurrently with the introduction of the gas comprising the plurality of monomers to the vessel. In embodiments, the apparatus is configured to introduce the gas comprising the plurality of monomers to the vessel prior to depositing the solution comprising the catalyst and the solvent on the substrate. In embodiments, the apparatus is configured to deposit the solution comprising the catalyst and the solvent on the substrate prior to the introduction of the gas comprising the plurality of monomers to the vessel.

The disclosure further provides articles prepared from the methods of the disclosure.

In embodiments, the apparatus can comprise an inkjet printer such as a SussMicroTec LP50 or equivalent with a printhead having solvent compatible reservoirs and lines such as a Fujifilm Emerald print head or equivalent. The apparatus can be configured to deposit nanoliter solvent drops of catalyst solution at high resolution. The printer can be further augmented with a monomer printing nozzle in fluid communication with a premixer ad a flow controller that allows manipulation of the monomer concentration in an inert gas carrier. The apparatus can further include as a substrate a vertical translation stage such as a ThorLab High-Load Automated Stage or equivalent, to allow 3D printing of the monomer.

The disclosure further provides articles comprising a plurality of stacked layers formed from solid polymer, the layers being coupled to one another in the z-direction. As used herein, and unless specified otherwise, layers of solid polymers are “coupled to one another” when the layers of solid polymers that are adsorbed, adhered, associated, or otherwise coupled to each other through any one or more of covalent bond formation, hydrogen bond formation, ionic bond formation (e.g., electrostatic attraction), and van der Waals interactions. In embodiments, the articles of the disclosure comprise a plurality of stacked layers formed from cyclic polyacetylene, the layers being coupled to one another in the z-direction, wherein the cyclic polyacetylene comprises from about 75% to about 100% frans-polyacetylene. In embodiments, the cyclic polyacetylene comprises about 80% to about 100% trans-polyacetylene, for example, about 85%, about 90%, about 95%, about 98%, or about 99% trans-polyacetylene.

The three-dimensional objects prepared by the methods and apparatus of the disclosure may be final, finished or substantially finished products, or may be intermediate products subject to further manufacturing steps such as surface treatment, laser cutting, electric discharge machining, etc., is intended.

Numerous different products can be made by the methods and apparatus of the present disclosure, including both large-scale products or devices, small custom products, miniature or microminiature products or devices, etc. The processes described herein can produce products with a variety of different properties. Hence in some embodiments the products are rigid; in other embodiments the products are flexible or resilient. In some embodiments, the products are a solid; in other embodiments, the products are a gel such as a hydrogel. In some embodiments, the products have a shape memory (that is, return substantially to a previous shape after being deformed, so long as they are not deformed to the point of structural failure). In some embodiments, the products are unitary (that is, formed of a single polymer); in some embodiments, the products are composites (that is, formed of two or more different polymers). Particular properties will be determined by factors such as the choice of polymerizable monomer(s) employed. The printed articles of the disclosure can be characterized for bulk and nanoscale conductivity. Bulk conductivity can be determined by depositing Au electrodes onto high-quality prints. In contrast to bulk conductivity determination of linear-polyacetylene, which has been assessed for powders, thin films, or highly contaminated morphologies, which does not allow removal of interfacial resistances associated with particle-particle or particle-electrode contacts, it is believed that the well-fabricated cyclic-polyacetylene will allow more reliable electronic measurements. To determine the bulk conductivity Au electrodes (100 microns×100 microns) are deposited as the substrate and coated with films of cyclic-polyacetylene in a van der Pauw geometry using the methods and apparatus of the disclosure. Top-contacts can be deposited on the films using, for example, shadow evaporation coupled to a cryogenic target stage to prevent damage to the underlying printed architecture. Such a structure allows determining if there is well-established electronic contact between multi-layers of printed polymer. Without intending to be bound by theory, it is believed that given the electronic homogeneity along the polymer backbone, due to the lack of chain ends, solitons present on the cyclic polymer backbone are more mobile than those in the linear polymer analogs. Further, without intending to be bound by theory, it is believed that these soliton quasi-particles exist in shallow potential energy wells and therefore may exhibit extremely high temperature dependent mobilities and bulk conductivities.

Nanoscale conductivity can be determined using conductive atomic force microscopy. Local structural changes can impact the bulk conductivity of a polymer and, therefore, it can be useful to characterize the nanoscale conductivity of a polymeric material. Nanoscale conductivity can be mapped in well-separated single droplets printed onto a conductive substrate. This allows determination of the electronic conductivity homogeneity within single droplets as a function of printing parameters. The conductivity of printed films can also be mapped to allow optimization of the uniformity of the electronic conductivity of a printed polymer, and reduction of domain interfaces that may add resistance to the system.

Electron mobilities can also be measured using high-quality printed films. Gated transistors with printed polymers as the channel material can be fabricated, which allows the measurement and determination of (1) transfer curves (I_{DS} vs V_{GS}), to determine carrier mobility, μ, and threshold voltage, V_{T}; (2) output curves (I_{DS} vs V_{GS}), to determine the channel resistance, RDS, and identification of whether the device exhibits FET behavior; and (3) gate leakage curves (I_{DS} vs V_{GS}), which enables characterization of the dielectric performance and leakage current. Together, these measurements allow identification of expected performance under n- or p-type operation, which may provide high on/off ratios commensurate with the unique identity of charge-carriers in cyclic polymers which do not have chain ends and include low chemical defects. These measurements can also inform how electronic characteristics of cyclic polymers differ from their linear analogues.

### EXAMPLES

### Materials and Methods

### Reagents

Unless specified otherwise, all manipulations were performed under an inert atmosphere using glovebox or Schlenk line techniques. Tetrahydrofuran (THF) and toluene were dried using a GlassContour (or equivalent) drying column. Acetylene was purchased from chemical suppliers, such as Airgas, and passed through a cold trap of acetone and dry ice, a column of activated carbon and 3 Å sieves prior to use. [^{t}BuOCO]W≡CC(CH₃)₃(THF)₂ (Catalyst 1), was prepared according to literature procedures (Veige et al., Nature Chemistry 2016, 8(8), 791-796). Titanium(IV) butoxide and triethylaluminum solution (25 wt %) in toluene were used as purchased from Sigma-Aldrich. Dopants, such as N-DMBI, CoCp₂, and NOPF₆, are readily available from chemical suppliers, such as Sigma-Aldrich and are used as purchased.

### NMR Spectroscopy

¹³C (150.92 MHz) NMR spectra can be collected on any appropriate spectrometer, utilizing either ¹H-¹³C Cross Polarization (CP) or ¹³C single-pulse experiments. CP can be accomplished with a 2.4 μs ¹H π/2 pulse followed by 1.9-ms ramped CP with a constant 55 kHz (¹³C) RF field. ¹³C one-pulse experiments can use a 5.6 us ¹³C π/2 pulse. ¹H decoupling of 86 kHz of ¹H (600.13 MHz) decoupling can be employed during 40-ms of signal acquisition. ¹³C spectra can be referenced externally with adamantane by setting the downfield resonance to 38.48 ppm.

### UV-Vis Spectroscopy

UV-vis spectra can be obtained on any appropriate spectrometer, such as a Cary 50 spectrophotometer or equivalent, optionally equipped with a temperature-controlled Unisoku single-cell accessory (±0.1° C.).

### Infrared Spectroscopy

Fourier transform infrared spectroscopy can be performed on any appropriate spectrometer, such as a Cary 630 FTIR (Agilent Technologies, Santa Clara, CA, USA) or equivalent. Raman spectroscopy can be performed on any appropriate spectrometer, such as a Horiba Aramis Raman system with a 10× object lens. Lasers with wavelengths of 633 nm and 785 nm and 600 g/mm and 1800 g/mm gratings can be used.

### Microscopy Protocols

Scanning electron microscope (SEM) images can be obtained on any appropriate scanning electron microscope, such as a Tescan MIRA3 scanning electron microscope or equivalent. The operating voltage can range from 0.2 to 30 keV with a Schottky field emission gun ZrO/W source. Energy dispersive X-ray spectroscopy (EDS) can be collected using any appropriate apparatus, such as a EDAX Octane Pro energy dispersive spectroscopy (EDS) system. Atomic force microscope (AFM) images can be obtained with a Dimension 3100 Scanning Probe Microscope (or equivalent) in the tapping mode with silicon tips.

### Conductivity Protocols

Sheet resistivities of the films can be measured with any appropriate apparatus, such as a Signatone Pro4-4400 4-point probe station (or equivalent) equipped with a Keithley 2400 (or equivalent) source meter. Film thickness can be measured using any appropriate profilometer.

### Example 1—Assembling and Operating an Apparatus for Printing Cyclicpolyalkyne Films from Gas Phase Alkyne Monomers

Assembling the Apparatus. An existing SOssMicroTec LP50 (or equivalent) inkjet printer was modified with a Fujifilm Emerald print head with solvent compatible reservoirs and lines. Specifically, a droplet-on-demand inkjet configuration was used which operates with a bipolar piezo waveform (˜40 kHz). The printer was further augmented by incorporating an alkyne printing nozzle with a premixer and flow controller that allows manipulation of the alkyne concentration in an inert carrier gas (e.g. N₂). Lastly, an automated stage, such as a ThorLab High-Load Automated Stage (or equivalent vertical translation stage), was installed to allow 3D printing of cyclicpolyalkyne films.

Operating the Apparatus. In a scintillation vial equipped with a magnetic stirrer, Catalyst 1 was dissolved in propylene glycol (˜5 μg/mL) and mixed thoroughly for 5 minutes to form the catalyst solution. The catalyst solution was filtered and transferred to the solvent compatible reservoir of the modified inkjet printer (˜10 mL). Separately, an Si/SiO₂ wafer, or an equivalent substrate (5 cm²), was placed under the inkjet print head on the automated stage in a vessel. Then, the catalyst solution was deposited from the printer on the Si/SiO₂ wafer in the desired pattern at a rate of 0.50 mL/s. After the desired pattern of catalyst solution was deposited, the patterned Si/SiO₂ wafer was exposed to a flow of acetylene gas premixed with N₂, using an acetylene concentration of 50 mol % relative to the total moles of gas, a flow rate of 100 mL/min., a temperature of 20° C., and a pressure of 120 kPa. Next, the acetylene was isolated from the gas flow and the vessel was purged with N₂. Once the vessel was purged, a second patterned layer of the catalyst solution was deposited on the solid polymer formed from the exposure of the first pattern to acetylene gas. Next, the second patterned layer of the catalyst solution was exposed to acetylene gas and formed another layer of the solid polymer. Then, the vessel was purged with N₂ and the patterned cyclicpolyacetylene film was obtained.

Generally, the Si/SiO₂ (or equivalent substrate) can be patterned with Catalyst 1 (or equivalent catalyst) solution, exposed to acetylene (or equivalent alkyne monomer), and purged with N₂ (or equivalent inert gas) as many times as desired.

Thus, Example 1 demonstrates the general assembly and operation of an apparatus of the disclosure for printing cyclicpolyalkyne films of the disclosure, specifically cyclicpolyacetylene films.

### Example 2—Characterization of Cyclicpolyalkyne Films

The cyclicpolyalkyne printed materials can be analyzed with several characterization methods, including spectroscopy, microscopy, and conductivity, to correlate desirable cyclicpolyalkyne film properties to the selections of solvents, gases, and parameters of the apparatus of the disclosure, as discussed in Example 2.

Solid-state CP-MAS ¹³C NMR spectroscopy can detect low defect formation and minimal cross-linking in the cyclicpolyalkyne film. Vibrational infrared and Raman spectroscopy can be used to evaluate the cis-Arans-ratio in the cyclicpolyalkyne film.

Scanning electron microscopy energy-dispersive X-ray spectroscopy (EDX) can detect agglomeration, uniformity, and average spacing between, of e.g, the tungsten sites from Catalyst 1, deposited on the substrate. Grazing-incidence X-ray diffraction measurements detect orientational-dependent mesostructural characteristics such as bulk property measurements (i.e. conductivity).

The electronic conductivity of multi-layer materials is characterized to determine the interfacial resistance related to iterative depositions. Consequently, local structural changes can greatly impact many polymers' bulk conductivity.

In order to investigate the bulk conductivity of cyclicpolyacetylene films, 100 μm×100 μm Au electrodes were patterned with cyclicpolyacetylene films using a procedure similar Example 1, with a van der Pauw geometry pattern. Temperature-dependent measurements were performed, indicating that the cyclicpolyacetylene film demonstrated in Example 1 features extremely high temperature-dependent mobility and thus high bulk conductivity.

In order to investigate the nanoscale conductivity of cyclicpolyacetylene films, single cyclicpolyacetylene droplets were printed onto a conductive substrate, following a similar procedure to that described in Example 1. Conductivity was measured across multiple single cyclicpolyacetylene droplets with a conductive atomic force microscope.

Thus, Example 2 demonstrates the general characterization of cyclicpolyalkyne films, specifically cyclicpolyacetylene films, using spectroscopic, microscopic, and conductivity measurements.

### Example 3—Synthesis and Characterization of Chemically Doped Cycloalkylalkyene Films

The conductivity of cyc-PA films produced by methods of the disclosure can be enhanced through chemical doping. Previously, I₂ doped cyc-PA has been shown to be highly conductive (400 S cm⁻¹) (Viege et al. Nature Chemistry 2021, 13, 792-799). However, iodine has several properties that render I₂ poorly suited to implement as a dopant in scale. For instance, I₂ is challenging to introduce in controlled amounts, I₂ is not matched well with the redox states of cyclicpolyacetylene, I₂ is volatile and spontaneously desorbs over time, and I₂ can undergo disproportionation, generating the ionic species, I₃⁻.

In contrast, redox agents including both n- and p-type (reduction and oxidation, respectively) can act as chemical dopants while overcoming inherent issues with I₂ doping. Several redox agents, both commercially available (N-DMBI, CoCp₂, and NOPF₆) and independently synthesized (Mo((SCH)₂)₃) are added to cyclicpolyalkyne films in substoichiometric amounts. Evaluation of the effect of dopants on cyclicpolyalkyne films based on size and reduction potential provide an understanding of long-range charge-delocalization in cyclicpolyalkyne films.

The electronic performance of doped cyc-PA was performed using a procedure similar to Example 1. However, a dopant was exposed to the solid polymer formed on the surface of the substrate for a specific amount of time (˜4 hours) after each patterned cyclicpolyalkyne film was deposited and prior to purging the vessel. Once the doped cyclicpolyalkyne film was isolated, characterization as described in Example 2 was performed.

Thus, Example 3 demonstrates the general preparation of a chemically doped cyclicpolyalkyne film, specifically a doped cyclicpolyacetylene film.

1. A method of preparing a three-dimensional article, comprising:
(a) depositing, from a deposition means, a solution comprising a catalyst and a solvent on a substrate to form a printed design;
(b) contacting the printed design with a gas comprising a plurality of monomers comprising alkynes, alkenes, or a combination thereof, thereby forming a first layer of solid polymer; and
(c) advancing the substrate away from the deposition means to form the three-dimensional article.

2. The method of claim 1, further comprising (d) repeating steps (a) to (c) once or more to form a second or further layer of solid polymer.

3. The method of claim 2, wherein at least a portion of the second layer of solid polymer is formed in contact with the first layer of solid polymer, such that stacked layers are formed in a z-direction, relative to the substrate.

4. The method of claim 1, wherein the contacting the printed design with the gas comprises introducing the gas into a closed container including the printed design.

5. The method of claim 1, wherein the contacting the printed design with the gas comprises depositing the printed design into a closed container including the gas.

6. The method of claim 1, wherein the contacting the printed design with the gas comprises depositing the printed design concurrently with introducing the gas comprising the plurality of monomers to a closed container comprising the deposition means and the substrate.

7. The method according to claim 2, further comprising (e) purging the closed container of the gas using an inert gas comprising N₂, Ar, Kr, Ne, Xe, or a combination thereof.

8. (canceled)

9. The method according to claim 1, further comprising contacting the solution of catalyst, solid polymer or both to a dopant.

10. The method according to claim 9, wherein the dopant comprises a p-type dopant and the p-type dopant comprises Br₂, I₂, Cl₂, AsF₅, Mo((SCH)₂)₃, or a combination thereof.

11. The method according to claim 9, wherein the dopant comprises an n-type dopant and the n-type dopant comprises lithium, sodium, potassium, N-dimethylbenzimadazoline (N-DMBI), or a combination thereof.

12. The method according to claim 1, further comprising contacting the solid polymer with an additional material, the additional matter comprising an oxygen impermeable material, a material to saturate a double bond of the polymer, a second polymer material, a metal, or a combination thereof.

13.-16. (canceled)

17. The method according to claim 1, wherein the catalyst comprises a metal-alkylidyne compound, a metallacycloalkylene compound, a metallacyclopropene compound, a metallacyclopentadiene compound, a tethered metallacyclobutane, and a combination thereof.

18. The method according to claim 1, wherein the catalyst comprises one or more of:

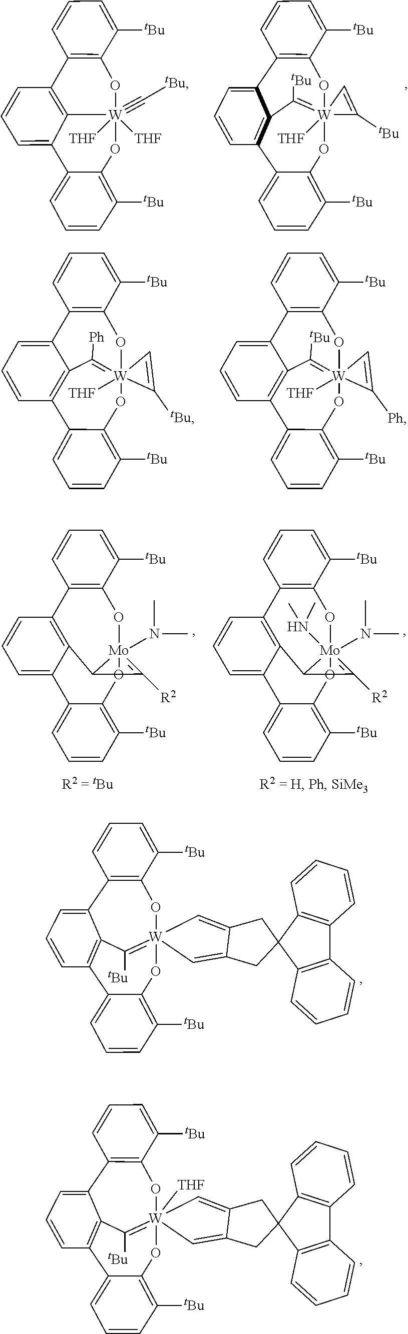

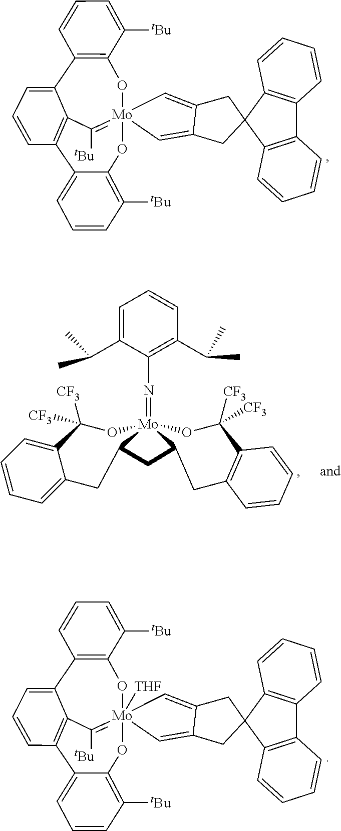

19. (canceled)

20. The method of claim 1, wherein solvent comprises propylene glycol, dichloromethane, tetrahydrofuran, ethyl acetate, diethyl ether, 1,4-dioxane, chloroform, pentane, hexane, benzene, pyridine, toluene, acetone, dimethylformamide (DMF), or a combination thereof.

21. The method of claim 1, wherein the catalyst is provided in the solution at a concentration of 0.001 μg of catalyst per mL of solvent (mg/mL) to 100 mg/mL.

22. The method of claim 1, wherein the plurality of monomers comprises a plurality of alkynes.

23.-24. (canceled)

25. The method of claim 1, wherein the plurality of monomers comprises acetylene, propyne, 1-butyne, 1-pentyne, 1-hexyne, or a combination thereof.

26. (canceled)

27. The method of claim 1, wherein the gas further comprises an aprotic solvent.

28.-29. (canceled)

30. The method of claim 1, wherein the contacting takes place in an inert atmosphere comprising N₂, Ar, Ne, Kr, Xe, or a combination thereof.

31.-33. (canceled)

34. The method of claim 1, wherein the contacting comprises flowing the gas over the printed design.

35.-36. (canceled)

37. The method of claim 1, wherein the deposition means comprises an ink jet printer.

38. The method of claim 1, wherein the depositing the solution of the catalyst on the substrate comprises extruding the solution of the catalyst at a rate of 0.01 mL/s to about 50 mL/s.

39. (canceled)

40. An article prepared according to the method of claim 1.

41. An article comprising:
a plurality of stacked layers formed from cyclicpolyacetylene, the layers being coupled to one another in a z-direction,
wherein the cyclic polyacetylene comprises from about 75% to about 100% trans-polyacetylene.

42. An apparatus for forming a three-dimensional object, comprising:
a vessel, the vessel containing:
a substrate; and
a deposition means configured to deposit a solution comprising a catalyst and a solvent on the substrate; and
at least one controller operatively associated with the deposition means and the substrate for advancing the substrate away from the deposition means;
wherein the vessel comprises a gas inlet and a gas outlet, the gas inlet fluidly coupled to a gas source to introduce a gas comprising a plurality of monomers to the vessel, such that when the plurality of monomers is contacted with the catalyst to form a polymer that makes up at least a portion of the three-dimensional object.

43.-73. (canceled)
